(19) United States
(12) Patent Application Publication
(10) Pub. No.: US 2021/0146333 A1
(43) Pub. Date: May 20, 2021

(54) TAILORED POROSITY MATERIALS AND METHODS OF MAKING AND USING SAME

(71) Applicant: IMMUTRIX THERAPEUTICS, INC., Rapid City, SD (US)

(72) Inventors: Oleksandr P. Kozynchenko, Rapid City, SD (US); Jose A. Diaz-Auñon, Rapid City, SD (US)

(21) Appl. No.: 16/772,969

(22) PCT Filed: Dec. 19, 2018
(86) PCT No.: PCT/US2018/066568

§ 371 Date: Jun. 15, 2020

Related U.S. Application Data
(60) Provisional application No. 62/607,432, filed on Dec. 19, 2017.
(60) Provisional application No. 62/673,573, filed on May 18, 2018.

(51) Int. Cl. B01J 20/20; B01J 20/28; C01B 32/336; C01B 32/318; C08G 8/10

(52) U.S. Cl. CPC B01J 20/20; B01J 20/28011; B01J 20/28083; B01J 20/28085; B01J 20/28033; C01P 2004/03; C01B 32/318; C08G 8/10; C01P 2006/11; C01P 2006/16; C01P 2004/04; C01B 32/336

(57) ABSTRACT

A carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1. Also, an adsorbent formed therefrom. Also, a chelating agent formed therefrom. Also, a film formed therefrom.

### CROSS-REFERENCE TO RELATED APPLICATIONS

This application is a filing under 35 U.S.C. 371 of International Application No. PCT/US2018/066568, filed Dec. 19, 2018, which claims priority to U.S. Provisional Application Ser. No. 62/607,432, filed Dec. 19, 2017 and entitled “Polycondensation Resins With Tailored Porosity and Methods of Making and Using Same” and to U.S. Provisional Application Ser. No. 62/673,573, filed May 18, 2018 and entitled “Novel Methods to Tailor Transport Porosity of Cured Phenolic Resins and Derived Carbon Materials,” each of which is incorporated herein by reference in its entirety.

### TECHNICAL FIELD

The present disclosure relates to novel resinous materials and methods of making and using same. More particularly, the present disclosure relates to polycondensation resinous materials, the preparation of said polycondensation resinous materials, carbonaceous materials derived from polycondensation resinous materials and methods of using and making same.

### BACKGROUND

Porous phenolic resins are currently manufactured and used as adsorbents under brand names such as AMBERLITE XAD761 (DOW CHEMICAL, ROHM&HAAS). Similar materials, now obsolete, have been manufactured by ROHM&HAAS as DUOLITE XAD761, DUOLITE S37 and DUOLITE S58.

Strongly acidic cation exchange resins can be prepared by the sulfonation of phenolic resins. Later, cation exchange resins derived from sulfonated porous phenolic resins have been manufactured in many countries under different names such as AMBERLITE IR100, AMBERLITE IR105 from DOW CHEMICAL, DUOLITE family of ARC9353, ARC9359, ARC9360, C10, C3ZEROLIT 215 from ROHM&HAAS, KU1 from the Soviet Union, LEWATIT DN and LEWATIT KSN from LANXESS, WOFATIT family—F, F2S, F4S, FF2S from BAYER. Now these products have become obsolete and were substituted on the market with cation exchangers derived mainly from polystyrene-divinylbenzene co-polymers.

Weak base anion exchange polycondensation resins can be prepared by the introduction of primary, secondary, or tertiary amino-groups into a polycondensation resin matrix. Examples of such resins include AMBERLYST A23 of DOW CHEMICAL, which is currently manufactured, whereas other such resins include AMBERLITE IR4B of DOW CHEMICAL, DOULITE family—A4F, A5, A561, A562, A568K, A569, A57, GPA327 of ROHM&HAAS, IONAC A330 of LANXESS, are already abandoned.

Chemical modification of a polycondensation matrix allows for the introduction of chelating groups (e.g., iminodiacetic, polyamine, etc.) resulting in metal ion scavengers with remarkable selectivity. Examples of such resins include the UNICELLEX family—UR10, UR120H, UR20, UR30, UR3300, UR370 0, UR3900, UR40, UR50 of UNITIKA.

Certain disadvantages of the aforementioned materials derive from their limited internal porosity and the irregular shape of their granules with related attrition problems during exploitation. These disadvantages may be attributable to the underlying phenolic matrix which typically was manufactured by bulk curing with subsequent milling.

A sol-gel process was also applied both in bulk curing and in suspension polycondensation manufacturing of polycondensation resins where high temperature boiling solvents were used as pore formers to tailor the porosity of the resulting resin blocks or beads. For example, using a NOVOLAC-Hexamine-Ethylene Glycol reaction system increasing the solvent content in pre-cured solution also resulted in increasing the pore size and pore volume of the cured resin.

An ongoing need exists to provide polycondensation resins and carbons derived from these resins whose porosity can be tailored to meet one or more user and/or process goals.

### SUMMARY

In some aspects is a carbonaceous material has a pore size (p) ranging from a lower limit (a) to an upper limit (z) and a bulk density (σ) ranging from a lower limit (b) to an upper limit (y) where the comparative variability (g) defined as (y−b)/(z−a) is less than 1. For example, the carbonaceous material may have a pore size ranging from about 10 nm to about 5000 nm and a bulk density ranging from 0.06 g/ml to 0.15 g/ml, or from about 20 nm to about 300 nm and a bulk density ranging from about 0.3 g/ml to about 0.5 g/ml, or from about 50 nm to about 150 nm and a bulk density ranging from about 0.3 g/ml to about 0.5 g/ml.

In some aspects is a polycondensation resin comprises a high-ortho phenol resin having a pore size ranging from about 10 nm to about 500 nm and an intraparticular density ranging from about 2% to about 25%. For example, the polycondensation resin may have a pore size of from about 25 nm to about 300 nm and an intraparticular porosity ranging from about 5% to about 20%, or a pore size of from about 50 nm to about 150 nm and an intraparticular porosity ranging from about 8% to about 15%. In some aspects, the polycondensation resin may comprise a chelating agent.

In some aspects, a carbonaceous material has a pore size (p) ranging from a lower limit (a) to an upper limit (z) and a bulk density (σ) ranging from a lower limit (b) to an upper limit (y) where the comparative variability (g) defined as (y−b)/(z−a) is less than 1×10⁻³. For example, the carbonaceous material may have a pore size ranging from about 10 nm to about 5000 nm and a bulk density ranging from 0.06 g/ml to 0.15 g/ml, or a pore size ranging from about 20 nm to about 300 nm and a bulk density ranging from about 0.3 g/ml to about 0.5 g/ml, or a pore size ranging from about 50 nm to about 150 nm and a bulk density ranging from about 0.3 g/ml to about 0.5 g/ml. The carbonaceous material may comprise an adsorbent or a film.

In some aspects, a carbonaceous material has a pore size (p) ranging from a lower limit (a) to an upper limit (z) and a bulk density (σ) ranging from a lower limit (b) to an upper limit (y) where the comparative variability (g) defined as (y−b)/(z−a) is less than 1×10⁻⁵. For example, the carbonaceous material may have a pore size ranging from about 10 nm to about 5000 nm and a bulk density ranging from 0.06 g/ml to 0.15 g/ml, or a pore size ranging from about 20 nm to about 300 nm and a bulk density ranging from about 0.3 g/ml to about 0.5 g/ml, or a pore size ranging from about 50 nm to about 150 nm and a bulk density ranging from about 0.3 g/ml to about 0.5 g/ml. The carbonaceous material may comprise an adsorbent.

### BRIEF DESCRIPTION OF THE DRAWINGS

FIG. 1 illustrates effects of pore former composition variations on porosity of cured resins.

FIG. 2 illustrates effects of pore former composition variations in cured resins on porosity of derived carbons.

FIG. 3 is an overlay of plots of the pore size and volume as a function of the percentage ethylene glycol in the resin composition for both the carbon material and the resin.

FIGS. 4A, 4B, and 4C are AFM images illustrating the effect of variations from FIG. 2 on the texture of corresponding carbons—AFM images.

FIG. 5 are SEM images of the internal texture of highly macroporous carbon bead and its external surface.

### DETAILED DESCRIPTION

Disclosed herein are polycondensation resins and carbonaceous materials derived therefrom having a tailored porosity. Herein porosity is referencing primarily the pore size. In an aspect, materials of the type disclosed herein may be tailored to have pore size in the range of from about 10 nm to about 5000 nm, alternatively from about 100 nm to about 2500 nm, or alternatively from about 200 nm to about 1000 nm. In some aspects, the tailored porosity resins (TPRs) disclosed herein are derived from a randomly-oriented precursor material and designated R-TPR (random). In another aspect, the tailored porosity resins (TPRs) disclosed herein are derived from a high-ortho precursor material and designated HO-TPR.

In an aspect, resins of the type disclosed herein (i.e., TPRs) and their derived carbon materials exhibit a pore size and pore volume that may be independently varied. In an aspect, the pore size is determined utilizing mercury-intrusion porosimetry to determine pore sizes ranging from about 10 nm to greater than about 5000 nm. In such aspects, the values of corresponding pore volumes have been estimated as specific volumes of intruded mercury. In an alternative or complementary aspect, pore sizes may be determined using nitrogen adsorption/desorption porosimetry at the appropriate temperature (e.g., −195.8° C.) given values of surface areas consistent within the BET model but applicable only for the pore size range of from about 1.5 nm to about 80 nm.

In an aspect, TPRs and carbons derived therefrom may be tailored to have a porosity ranging from about 10 nm to about 5000 nm, alternatively from about 100 nm to about 1000 nm or alternatively from about 200 nm to about 800 nm and may be further characterized by a concomitant change in bulk density of less than about 50%, alternatively less than about 45%, alternatively less than about 40%, alternatively less than about 35%, alternatively less than about 30%, alternatively less than about 25%, alternatively less than about 20%, alternatively less than about 15%, or alternatively less than about 10%. In an aspect, TPRs and carbons derived therefrom may be tailored to have a porosity ranging from about 10 nm to about 5000 nm, alternatively from about 100 nm to about 1000 nm or alternatively from about 200 nm to about 800 nm and may be further characterized by a concomitant change in pore volume of less than about 50%, alternatively less than about 45%, alternatively less than about 40%, alternatively less than about 35%, alternatively less than about 30%, alternatively less than about 25%, alternatively less than about 20%, alternatively less than about 15%, or alternatively less than about 10%.

Without wishing to be limited by theory, TPRs and carbons derived therefrom of the type disclosed herein are characterized by unusual and precisely custom-regulated structures. Further, the TPRs of this disclosure represent structured materials that retain their interconnected pore texture following carbonization thus providing carbonaceous materials having unhindered access to active sites on the material (e.g., adsorption, catalytic, ion-exchange or chelating sites).

It is contemplated herein that although polycondensation resins have protonogenic (phenolic hydroxyl-groups or carboxylic groups from modifying agents like salicylic acid and the like) or proton-accepting (amino-groups from modifying agents like aromatic or heteroaromatic amines) groups in their matrix, additional ion-exchange and/or chelating sites could be introduced by any suitable methodology. These include but are not restricted to sulfonation, chloromethylation followed by amination; etc.

Porous polycondensation resins of the present disclosure could be easily converted by any suitable methodology (e.g., carbonization) into porous carbons which inherit their meso/macroporosity from the resin-precursor. In an aspect, the carbonaceous materials derived from TPRs of the type disclosed herein are characterized by surface areas ranging from about 200 m²/g to about 2000 m²/g, alternatively from about 500 m²/g to about 1500 m²/g or alternatively from about 500 m²/g to about 1000 m²/g. Without wishing to be limited by theory, carbonized materials of the present disclosure may exhibit larger surface areas due at least in part to nanopores (pores with diameter below 2 nm) appearing in the course of carbonization. In an aspect, carbonaceous materials derived from TPRs of the type disclosed herein may have the surface area modified by additional processing for example the surface area may be increased through activation.

In an aspect, a method of preparing a TPR of the type disclosed herein comprises a polycondensation process. In an alternative aspect, a method of preparing a TPR of the type disclosed herein consists or consists essentially of a polycondensation process. A polycondensation process of the present disclosure involves the following major components (i) a nucleophilic component (non-limiting examples of which include—NOVOLAC phenol-formaldehyde linear pre-polymers with or without the addition of modifying nucleophilic amines (e.g.—aniline, phenylenediamines, aminophenols, melamine), dihydric phenols, phenolcarboxylic acids (such as and without limitation salicylic acid and 5-resorcilol carboxylic acid) and other compounds with multiple nucleophilic sites; (ii) a cross-linking electrophilic component, non-limiting examples of which include hexamethylenetetramine (hexamine), or formaldehyde; (iii) a solvent/pore former, non-limiting examples of which include ethylene glycol, which may or may not contain modifying additives (such as and without limitation water and polyols); and (iv) a solubility modifying agent, non-limiting examples of which include without limitation sodium hydroxide or another alkaline agent soluble in the solvent/pore former.

In an aspect, the linear phenol-formaldehyde pre-polymers NOVOLAC comprise the major nucleophilic component of the polycondensation reaction composition. In an alternative aspect, the major nucleophilic component of the polycondensation reaction composition consists essentially of the linear phenol-formaldehyde pre-polymers NOVOLACs. In an alternative aspect, the major nucleophilic component of the polycondensation reaction composition consists of the linear phenol-formaldehyde pre-polymers NOVOLACs.

As understood by the ordinarily skilled artisan, there are two types of industrially manufactured phenol-formaldehyde NOVOLACs. The most common of these materials are randomly substituted NOVOLACs with differing average molecular masses, including o,o-, o,p- and p,p-variants of substitution using standard organic nomenclature where o refers to the ortho position and p refers to the para position. Structures involving substitution into m-position are practically absent. However randomly substituted NOVOLAC are characterized by an average molecular weight of approximately 330 g/mol with ˜24% of p,p′-, ˜49% of o,p- and ˜28% of o,o′-substitutions as determined by NMR ¹³C-studies. In contrast, high o,o′-substituted NOVOLAC is characterized by an average molecular weight of approximately 470 g/mol with ˜1% of p,p′-, ˜37% of o,p- and ˜59% of o,o′-substitutions. Without wishing to be limited by theory, a high proportion of o,o′-substitutions enables the self-assembling of tetramers and higher oligomers into quasi-cyclic structures stabilized by hydrogen bonds between uniformly oriented phenolic hydroxy-groups. These ordered structures are believed to survive the curing sol-gel process and provide chelating sites in meso/macroporous polycondensation resins. These sites are reminiscent of crown-ethers that form highly stable complexes with alkali and alkali earth metal ions. Some of them are also highly ion-size selective. Again, without wishing to be limited by theory, the formation of such ordered structures may stabilize the cured resin matrix, so that it's glass transition temperature T_{g} remains higher than the decomposition temperature range (e.g., 350° C.-400° C.) even in the presence of large quantities of pore former ethylene glycol. In stark contrast, for cured randomly substituted NOVOLACs the removal of major quantities of ethylene glycol is carried out prior to carbonization in order to preserve the porous texture from collapsing because of the glass transition on heating. In an aspect of the present disclosure, the TPR is a chelator able to selectively bind monovalent or divalent cations. For example, the TPR may selectively bind alkali metals or alkali earth metals. In such examples the TPR may function as a chelating agent having formation constants, K_{f}, ranging from about 1×10³ to about 1×10¹⁵ depending on the cation being chelated, alternatively from about 1×10⁵ to about 1×10¹² or alternatively from about 1×10⁵ to about 1×10¹⁰.

In some aspects of the present disclosure, other nucleophilic modifying agents capable of polycondensation with formaldehyde or its analogues are employed alongside NOVOLACs in the production of materials of the present disclosure in order to (i) introduce additional ion-exchange groups into the porous matrix (e.g., aromatic and heteroaromatic amines, hydroxy-substituted aromatic carboxylic, sulfonic, phosphonic, boronic acids), to modify the porosity (e.g., urea, melamine) or (ii) to introduce heteroatoms (e.g., nitrogen, phosphorus, boron) into the matrix of the TPRs or carbons derived therefrom.

In some aspects, nitrogen-containing functionalities are introduced into the materials of the present disclosure via cross-linking agents such as hexamethylenetetramine (hexamine) or soluble poly-methylol derivatives of urea and melamine. As will be understood by the ordinarily skilled artisan, the stoichiometric quantity of formaldehyde required for substitution of all three reactive positions in phenolic molecule to form a cross-linked phenol-formaldehyde network is 1.5 moles per 1 mole of phenol. Without wishing to be limited by theory, mechanistically approximately 0.7 moles of formaldehyde per mole of phenol may be employed in the preparation of linear NOVOLAC pre-polymer while an additional 0.5-0.8 moles of formaldehyde or it's synthone or synthetic equivalent could be used for stochiometric cross-linking of the material. In common practice excessive quantities of cross-linking agents are used. The present disclosure contemplates the use of an excess of crosslinking agent. Hexamine, for example, may be added in quantities ranging from about 10 to about 30 weight parts to about 100 weight parts of NOVOLAC to produce solid cross-linked porous resin, although the theoretical quantity ranges from about 14 to about 16 weight parts depending on NOVOLAC type. Such variation in composition could result in alterations of the porous structure of the resulting resins and other parameters such as the ability of the resin to swell. The use of an excess of crosslinking agent may also affect the reactivity of carbon matrix of porous carbons derived from the corresponding resins (i.e., TPRs).

Porosity in polycondensation resins of the present disclosure develops in the course of steady growing of cross-linked resin domains occurring at elevated temperature, for example from about 40° C. to about 200° C., alternatively from about 50° C. to about 175° C. or alternatively from about 70° C. to about 150° C. Without being limited by theory, it is contemplated that during the elevated temperature, at some stage, a nano-scale phase separation of resin rich phase (still containing some solvent) and solvent rich phase that still contains some linear or partially cross-linked polymer and curing agent occurs resulting in the formation of an interpenetrated network of pores. Typically, at this point the liquid polycondensation resin solution turns solid (sol-gel transformation). It is further contemplated that different transformations of initially formed benzoxazine and benzylamine bridging structures (when hexamine is a curing agent) take place alongside further growth of resin domains at the expense of partially-cured polymer from the solution-rich phase. On further heating evolution of gaseous ammonia and amines occurs and the resin turns from translucent to opaque.

Surprisingly, it has recently been discovered and it is disclosed herein that substitution of a relatively small fraction of solvent/pore former (for example ethylene glycol) by water leads to significant increasing of the pore size without meaningful changes in pore volumes.

Another novel method to tailor porosity of polycondensation resins relies on the alteration of the solubility of polycondensation resins by addition of minute quantities of alkaline agents (e.g., sodium hydroxide) to the reaction composition. In a surprisingly beneficial aspect, catalytic activity was not observed when utilizing alkali materials although such materials were previously utilized as catalysts in the polycondensation reactions of phenols.

In an aspect of the present disclosure, the TPRs and derived carbonaceous materials may be formed into any user-desired or process-desired shape. In a nonlimiting example, the TPRs and derived carbonaceous materials are formed into blocks or monoliths. In another nonlimiting example, the TPRs and derived carbonaceous materials are formed into beads. In such an example, the average bead may range from about 5 μm to about 2000 μm, alternatively from about 50 μm to about 1000 μm or alternatively from about 250 μm to about 750 μm.

In an aspect, the carbonaceous materials derived from TPRs of the type disclosed herein are produced with a narrow particle size distribution e.g. with a D₉₀/D₁₀ of greater than about 10, alternatively greater than about 8, or alternatively greater than about 5.

In an aspect, TPRs of the type disclosed herein are used to form a carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1, alternatively less than 1×10⁻², alternatively less than 1×10⁻³ or alternatively less than 1×10⁻⁵. In such aspects a may have a value of from about 10 nm to about 1000 nm, alternatively from about 10 nm to about 750 nm or alternatively from about 50 nm to about 500 nm; z may have a value of from about 500 nm to about 5000 nm, alternatively from about 1000 nm to about 4000 nm or alternatively from about 1500 nm to about 3000 nm; b may have a value ranging from about 0.05 to about 0.2, alternatively form about 0.08 to about 0.2 or alternatively from about 0.1 to about 0.2 and y may have a value ranging from about 0.1 to about 0.4, alternatively from about 0.15 to about 0.4 or alternatively from about 0.2 to about 0.4.

In an aspect, the TPR has a pore size ranging from about 10 nm to about 500 nm and an intraparticular porosity ranging from about 2% to about 25%. Herein the intraparticular porosity refers to the ratio of void volume to material density and can be derived from the mercury porosimetry data. In an alternative aspect, the TPR has a pore size ranging from about 25 nm to about 300 nm with an intraparticular porosity ranging from about 5% to about 20% or alternatively a pore size ranging from about 50 nm to about 150 nm with an intraparticular porosity ranging from about 8% to about 15%. In an aspect, a carbonaceous material derived from a TPR of the type disclosed herein has a pore size ranging from about 10 nm to about 5000 nm with a bulk density ranging from about 0.06 g/ml to about 0.15 g/ml, alternatively a pore size ranging from about 20 nm to about 300 nm with a bulk density ranging from about 0.3 g/ml to about 0.5 g/ml or alternatively a pore size ranging from about 50 nm to about 150 nm with a bulk density ranging from about 0.3 g/ml to about 0.5 g/ml.

TPRs of the type disclosed herein and the carbonaceous materials derived therefrom may be utilized in a wide-variety of applications. In one aspect, the TPRs and carbonaceous materials derived therefrom are further processed to provide medical-grade adsorbents which effect the removal of one or more target molecules from a bodily fluid such as for example and without limitation whole blood, plasma, urine and cerebrospinal fluid. In such aspects, the target molecule may be an inflammatory mediator (e.g., cytokine), a cellular signaling molecule or protein. In an alternative aspect, TPRs and carbonaceous materials derived therefrom are utilized as support materials such as catalyst supports. In yet another aspect, TPRs and carbonaceous materials derived therefrom may be further processed (e.g., oxidized) and serve as catalysts for the production of oxidants (e.g., hydrogen peroxide) or may catalyze the oxidation of one or more molecules. In another aspect, TPRs and carbonaceous materials derived therefrom may find utility as components of one or more articles fashioned to enhance the structural, thermal, or mechanical characteristics of an apparatus.

The following illustrates additional and/or alternative aspects of the subject matter disclosed herein.

For example, a first aspect is a carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1.

A second aspect is the material of the first aspect having a pore size ranging from about 10 nm to about 5000 nm and a bulk density ranging from 0.06 g/ml to 0.15 g/ml.

A third aspect is the material of one of the first through the second aspects having a pore size ranging from about 20 nm to about 300 nm and a bulk density ranging from about 0.3 g/ml to about 0.5 g/ml.

A fourth aspect is the material of one of the first through the third aspects having a pore size ranging from about 50 nm to about 150 nm and a bulk density ranging from about 0.3 g/ml to about 0.5 g/ml.

A fifth aspect is a polycondensation resin comprising a high-ortho phenol resin having a pore size ranging from about 10 nm to about 500 nm and an intraparticular density ranging from about 2% to about 25%.

A sixth aspect is the resin of the fifth aspect having a pore size of from about 25 nm to about 300 nm and an intraparticular porosity ranging from about 5% to about 20%.

A seventh aspect is the resin of one of the fifth through the sixth aspects having a pore size of from about 50 nm to about 150 nm and an intraparticular porosity ranging from about 8% to about 15%.

An eighth aspect is a chelating agent comprised of the material of one of the fifth through the seventh aspects.

A ninth aspect is a carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1×10⁻³.

A tenth aspect is the material of the ninth aspect having a pore size ranging from about 10 nm to about 5000 nm and a bulk density ranging from 0.06 g/ml to 0.15 g/ml.

An eleventh aspect is the material of one of the ninth through the tenth aspects having a pore size ranging from about 20 nm to about 300 nm and a bulk density ranging from about 0.3 g/ml to about 0.5 g/ml.

A twelfth aspect is the material of one of the ninth through the eleventh aspects having a pore size ranging from about 50 nm to about 150 nm and a bulk density ranging from about 0.3 g/ml to about 0.5 g/ml.

A thirteenth aspect is an adsorbent comprising the carbonaceous material of one of the ninth through the twelfth aspects.

A fourteenth aspect is an adsorbent comprising the carbonaceous material of one of the ninth through the thirteenth aspects.

A fifteenth aspect is a film comprising the carbonaceous material of one of the ninth through the fourteenth aspects.

A sixteenth aspect is a carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1×10⁻⁵.

A seventeenth aspect is the material of the sixteenth embodiment having a pore size ranging from about 10 nm to about 5000 nm and a bulk density ranging from 0.06 g/ml to 0.15 g/ml.

An eighteenth aspect is the material of one of the sixteenth through the seventeenth aspects having a pore size ranging from about 20 nm to about 300 nm and a bulk density ranging from about 0.3 g/ml to about 0.5 g/ml.

A nineteenth aspect is the material of one of the sixteenth through the eighteenth aspects having a pore size ranging from about 50 nm to about 150 nm and a bulk density ranging from about 0.3 g/ml to about 0.5 g/ml.

A twentieth aspect is an adsorbent comprising the carbonaceous material of one of the sixteenth through the nineteenth aspects.

Additional modes for utilization of the materials disclosed herein would be apparent to one of ordinary skill in the art with the benefit of this disclosure.

### EXAMPLES

The subject matter of the present disclosure having been generally described, the following examples are given as particular aspects of the disclosure and to demonstrate the practice and advantages thereof. It is understood that the examples are given by way of illustration and are not intended to limit the specification or the claims to follow in any manner.

The examples below provide preparation details of cured resin beads of different formulations and describe both a comparative method (Examples 1, 4, 5, 6, 7) and methods of the present disclosure. Carbonized beads derived from resins (i.e., carbonaceous materials) of examples 1 to 10 are designated utilizing the system Examples 1-1, 2-1, etc. . . . .

### Example 1

TPRs and carbonaceous materials of the type disclosed herein were prepared and their properties investigated. A hot solution (85° C.-90° C.) of 100 weight parts of HO-NOVOLAC in 135 weight parts of ethylene glycol was blended with hot solution (85° C.-90° C.) of 20 weight parts of hexamine in 135 weight parts of ethylene glycol. The resulting hot resin solution was poured into 2000 weight parts of stirred hot (145° C.) mineral oil containing 4 weight parts of the drying oil and formed an emulsion which was formed into beads and further heated. The slurry beads were then separated from the oil and carbonized.

Example 1-1

The resin beads of Example 1 were carbonized in shallow bed tray in the tube furnace in the flow of carbon dioxide. The temperature was ramped from 20° C. to 800° C. in 200 min and held there for 30 min. After cooling down the carbon beads were classified with test sieves, and the 250/500 μm fraction was subjected to further analyses.

### Example 2

TPRs and carbonaceous materials of the type disclosed herein were prepared and their properties investigated. A hot solution (85° C.-90° C.) of 100 weight parts of HO NOVOLAC in 120 weight parts of ethylene glycol was blended with hot solution (85° C.-90° C.) of 20 weight parts of hexamine in 123 weight parts of ethylene glycol and 27 weight parts of water. The resulting hot resin solution was poured into 2000 weight parts of stirred hot (135° C.) mineral oil containing 4 weight parts of the drying oil and formed an emulsion which was formed into beads and further heated. The slurry beads were then separated from the oil and carbonized as in Example 1-1 without further processing. Analytical samples were prepared as in Example 1.

### Example 2-1

The resin beads of Example 2 were carbonized in shallow bed tray in the tube furnace in the flow of carbon dioxide. The temperature was ramped from 20° C. to 800° C. in 200 min and held there for 30 min. After cooling down the carbon beads were classified with test sieves, and the 250/500 μm fraction was subjected to further analyses.

### Example 3

TPRs and carbonaceous materials of the type disclosed herein were prepared and their properties investigated. A hot solution (85° C.-90° C.) of 100 weight parts of HO NOVOLAC in 135 weight parts of ethylene glycol containing 1.2 weight parts of sodium hydroxide was blended with hot solution (85° C.-90° C.) of 20 weight parts of hexamine in 135 weight parts of ethylene glycol. The resulting hot resin solution was poured into 2000 weight parts of stirred hot (135° C.) mineral oil containing 4 weight parts of the drying oil and formed an emulsion which was formed into beads and further heated.

These beads were washed 2 times with hot (80° C.-90° C.) water (2000 weight parts each time) and dried to free-flowing condition on air. Analytical samples were prepared by extraction with propanol-2-ol and vacuum drying.

### Example 3-1

Water-washed resin beads were carbonized and further processed as in Examples 1-1 and 2-1 but heat treatment was carried out in the flow of nitrogen.

### Example 4

Carbonaceous materials of the type disclosed herein were prepared and their properties investigated. A hot solution (85° C.-90° ° C.) of 100 weight parts of R NOVOLAC in 90 weight parts of ethylene glycol was blended with hot solution (85° C.-90° C.) of 20 weight parts of hexamine in 90 weight parts of ethylene glycol. The resulting hot resin solution was poured into 2000 weight parts of stirred hot (140° C.) mineral oil containing 4 weight parts of the drying oil and formed an emulsion which was formed into beads and further heated. These beads were washed 2 times with hot (80° C.-90° C.) water (2000 weight parts each time) and dried to free-flowing condition on air. Analytical samples were prepared by extraction with propanol-2-ol and vacuum drying.

### Example 4-1

Water-washed resin beads were carbonized and further processed as in Examples 1-1 and 2-1.

### Example 5

TPRs and carbonaceous materials of the type disclosed herein were prepared and their properties investigated. A hot solution (85° C.-90° C.) of 100 weight parts of R NOVOLAC in 250 weight parts of ethylene glycol was blended with a hot solution (85° C.-90° C.) of 20 weight parts of hexamine in 290 weight parts of ethylene glycol. The resulting hot resin solution was poured into 2000 weight parts of stirred hot (143° C.) mineral oil containing 4 weight parts of the drying oil and formed an emulsion which was formed into beads and further heated. After cooling the slurry beads were separated from the oil either by filtration or centrifugation. These beads were washed 2 times with hot (80° C.-90° C.) water (2000 weight parts each time) and dried to free-flowing condition on air. Analytical samples were prepared by extraction with propanol-2-ol and vacuum drying.

### Example 5-1

Water-washed resin beads were carbonized and further processed as in Examples 1-1, 2-1 and 4-1.

### Example 6

TPRs and carbonaceous materials of the type disclosed herein were prepared and their properties investigated. A hot solution (85° C.-90° C.) of 100 weight parts of HO NOVOLAC in 90 weight parts of ethylene glycol was blended with hot solution (85° C.-90° C.) of 20 weight parts of hexamine in 90 weight parts of ethylene glycol. The resulting hot resin solution was poured into 2000 weight parts of stirred hot (133° C.) mineral oil containing 4 weight parts of the drying oil and formed an emulsion which was formed into beads and further heated. After cooling the slurry beads were separated from the oil either by filtration or centrifugation. These resin beads were carbonized without further treatment. Analytical samples were prepared by hot water washing followed by extraction with propanol-2-ol and vacuum drying.

### Example 6-1

Resin beads of Example 6 were carbonized and further processed as in Examples 1-1, 2-1, 4-1 and 5-1.

### Example 7

TPRs and carbonaceous materials of the type disclosed herein were prepared and their properties investigated. A hot solution (85° C.-90° C.) of 100 weight parts of HO NOVOLAC in 225 weight parts of ethylene glycol was blended with hot solution (85° C.-90° C.) of 20 weight parts of hexamine in 225 weight parts of ethylene glycol. The resulting hot resin solution was poured into 2000 weight parts of stirred hot (141° C.) mineral oil containing 4 weight parts of the drying oil and formed an emulsion which was formed into beads and further heated. After cooling the slurry beads were separated from the oil either by filtration or centrifugation. These resin beads were carbonized without further treatment. Analytical samples were prepared by hot water washing followed by extraction with propanol-2-ol and vacuum drying.

### Example 7-1

Resin beads of Example 7 were carbonized and further processed as in Examples 1-1, 2-1, 4-1, 5-1 and 6-1.

### Example 8

TPRs and carbonaceous materials of the type disclosed herein were prepared and their properties investigated. A hot solution (85° C.-90° C.) of 100 weight parts of HO NOVOLAC in 80 weight parts of ethylene glycol was blended with hot solution (85° C.-90° C.) of 20 weight parts of hexamine in 72 weight parts of ethylene glycol and 27 weight parts of water. The resulting hot resin solution was poured into 2000 weight parts of stirred hot (125° C.) mineral oil containing 4 weight parts of the drying oil and formed an emulsion which was formed into beads and further heated. After cooling the slurry beads were separated from the oil either by filtration or centrifugation. These resin beads were carbonized without further treatment. Analytical samples were prepared by hot water washing followed by extraction with propanol-2-ol and vacuum drying.

### Example 8-1

Resin beads of Example 8 were carbonized and further processed as in Examples 1-1, 2-1, 4-1, 5-1, 6-1 and 7-1.

### Example 9

TPRs and carbonaceous materials of the type disclosed herein were prepared and their properties investigated. A hot solution (85° C.-90° C.) of 100 weight parts of HO NOVOLAC in 80 weight parts of ethylene glycol containing 0.6 weight parts of sodium hydroxide was blended with hot solution (85° C.-90° C.) of 20 weight parts of hexamine in 100 weight parts of ethylene glycol. The resulting hot resin solution was poured into 2000 weight parts of stirred hot (125° C.) mineral oil containing 4 weight parts of the drying oil and formed an emulsion which was formed into beads and further heated. After cooling the slurry beads were separated from the oil either by filtration or centrifugation. These beads were washed 2 times with hot (80-90° C.) water (2000 weight parts each time) and dried to free-flowing condition on air. Analytical samples were prepared by extraction with propanol-2-ol and vacuum drying.

### Example 9-1

Water-washed resin beads were carbonized and further processed as in Example 3-1.

### Example 10

TPRs and carbonaceous materials of the type disclosed herein were prepared and their properties investigated. A hot solution (85° C.-90° C.) of 100 weight parts of HO NOVOLAC in 170 weight parts of ethylene glycol was blended with hot solution (85° C.-90° C.) of 20 weight parts of hexamine in 154 weight parts of ethylene glycol and 36 weight parts of water. The resulting hot resin solution was poured into 2000 weight parts of stirred hot (130° C.) mineral oil containing 4 weight parts of the drying oil and formed an emulsion which was formed into beads and further heated. After cooling the slurry beads were separated from the oil either by filtration or centrifugation. These resin beads were carbonized without further treatment. Analytical samples were prepared by hot water washing followed by extraction with propanol-2-ol and vacuum drying.

### Example 10-1

Resin beads of Example 8 were carbonized and further processed as in Examples 1-1, 2-1, 4-1, 5-1, 6-1, 7-1 and 8-1.

### Example 11

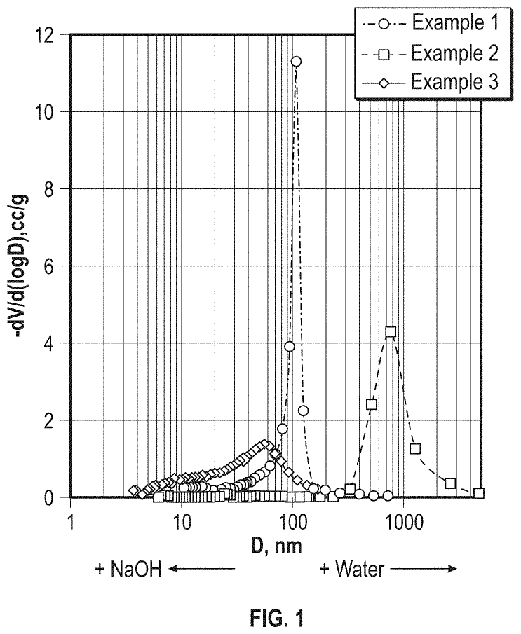

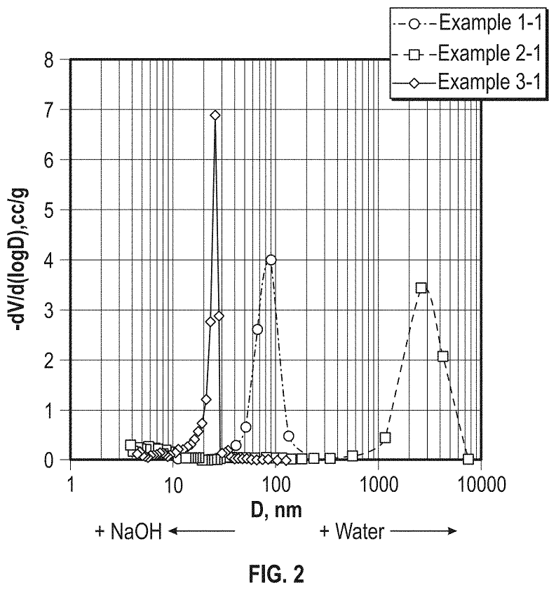

Samples prepared as described in the previous examples were further analyzed. FIG. 1 is a graph depicting the pore size of a TPR as a function of water or sodium hydroxide while FIG. 2 is a graph depicts the pore size of the carbonize material derived from the TPR also a function of water and sodium hydroxide amount. Table 1 summarizes the values plotted for both figures. FIG. 1 shows a porosity variation for resin compositions containing 225 weight % of pore former regarding the total high-ortho (HO) NOVOLAC and hexamine content in the composition (NOVOLAC to hexamine weight ratio 5/1). The pore former level could be variated as looks technologically viable (because of certain solubility and viscosity restrictions). As demonstrated, pore sizes of the materials disclosed herein could be varied by methods of the present disclosure while pore volumes are observed to be to a great extent predetermined by the level of pore former loading. This creates a useful matrix of opportunities for creation of resin structure with desired pore volume and pore size. Examples 1 and 1-1 represent a comparative resin and carbonized beads.

TABLE 1

| Example | Pore size | Bulk density, | Intraparticular | SBET, |
|---|---|---|---|---|
| No. | max., nm | g/cc | porosity, % | m²/g |
| 1 | 107.8 | n/d | 16.10 | 125 |
| 1-1 | 89.1 | 0.30 | 12.07 | 586 |
| 2 | 769.4 | n/d | 13.44 | 2 |
| 2-1 | 2616 | 0.25 | 11.52 | 562 |
| 3 | 57.8 | n/d | 10.7 | 207 |
| 3-1 | 26.3 | 0.43 | 8.01 | 612 |

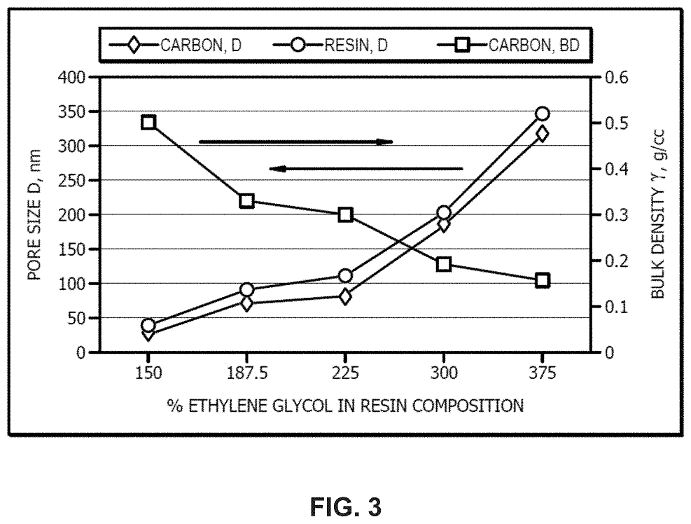

Data from FIGS. 1 and 2 and Table 1 illustrate the relationship between resin and carbon porosity observed for the materials of the present disclosure. Particularly, it was observed that (i) pores in cured resins, prepared with pure ethylene glycol as well as with ethylene glycol containing sodium hydroxide, are larger than pores of derived carbons; pores of cured resins prepared with aqueous ethylene glycol as a pore former are smaller than pores of derived carbons; (ii) the addition of sodium hydroxide to resin composition results in broad pore size distribution in cured resins whereas derived carbonized materials exhibit sharp pore size maxima; (iii) the addition of sodium hydroxide to resin composition results in moderate reduction of pore sizes both in resins and derived carbons and moderate changes in pore volume related parameters; and (iv) the addition of water to resin composition results in significant increase of pore size of cured resins and derived carbons with less than moderate effect on pore volume related parameters. It was observed that for the materials of the present disclosure, an increase in pore size correlated with a decrease of bulk density (increase of pore volume) and potentially—with progressive deterioration of volumetric performance of carbons with bigger macropores. On the other hand, mesoporous carbons (D<50 nm) have high bulk densities and relatively low pore volumes. Objectives of the present invention are to provide carbons with: i) pores in excess of 0.5μ in diameter and relatively high bulk density; and ii) mesopores of relatively high volume (lower bulk density). FIG. 3 is an overlay of plots of the pore size and volume as a function of the percentage ethylene glycol in the resin composition for both the carbon material and the resin.

TABLE 2

| Example | Pore size | Bulk density, | Intraparticular | SBET, |
|---|---|---|---|---|
| No. | max., nm (Hg) | g/cc | porosity, % | m²/g |
| 4 | 13.5 | n/d | 3.90 | 79 |
| 4-1 | 12.0 | 0.54 | 3.49 | 607 |
| 5 | 138.3 and 284.4 | n/d | 21.68 | 40 |
| 5-1 | 386.7 | 0.16 | 22.42 | 503 |
| 6 | 34.0 | n/d | 4.55 | 75 |
| 6-1 | 27.2 | 0.51 | 3.20 | 520 |
| 7 | 373.8 | n/d | 22.43 | 44 |
| 7-1 | 308.6 | 0.16 | 16.05 | 551 |
| 8 | 370.2 | n/d | 3.67 | 0.6 |
| 8-1 | 1912.4 | 0.33 | 9.06 | 574 |
| 9 | 21.8 | n/d | 7.56 | 160 |
| 9-1 | 14.1 | 0.56 | 3.01 | 648 |
| 10 | 571.1 and 983.4 | n/d | 17.08 | 0.1 |
| 10-1 | 3688.1 | 0.20 | 16.98 | 554 |

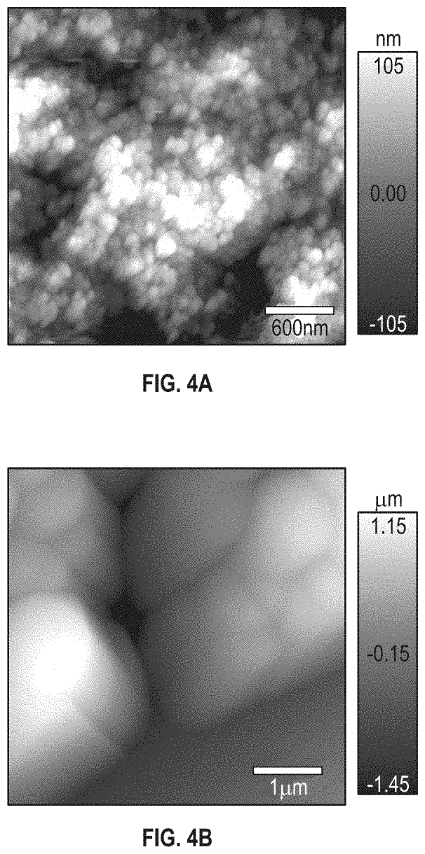

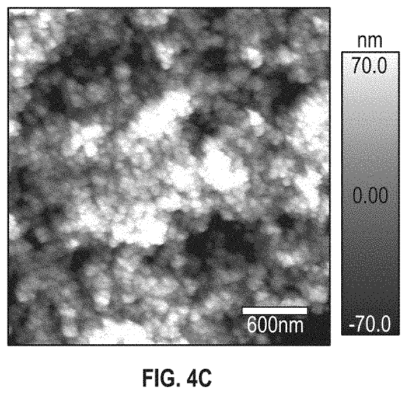

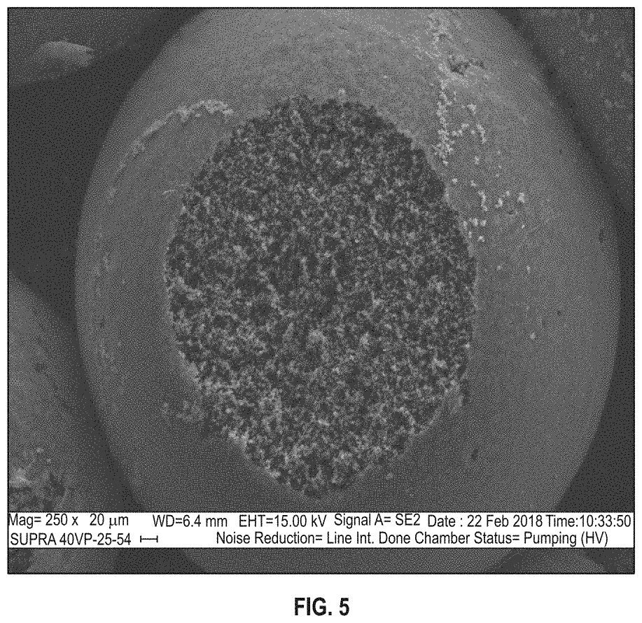

Referring to FIGS. 4 and 5, AFM imaging was performed on carbon samples of examples 1-1, 2-1 and 3-1. Enclosed are topographical images, histograms of height data, and roughness values for the images enclosed.

Both atomic force microscopy (AFM) and scanning electron microscopy (SEM) images of nano-architecture within the carbon beads demonstrated an interconnected network of transport pores with walls formed of clusters of spheroid carbon domains. The domain size was determined to be 100-110 nm for the carbon of Example 1-1, 60-75 nm for “alkaline” carbon of Example 3-1 and 1-2μ for “aqueous” carbon of Example 2-1 This alteration of the nano-domain sizes explains the dramatic change of pore sizes in carbons derived from the resins with the same Pore Former/(NOVOLAC+Hexamine) weight ratio (see FIG. 1). Same is believed to be valid for precursor resins as well.

Resulting imaging shows that the majority of the pore structure appeared to be made from the interconnected network of spheroidal agglomerations within the spherical granule (bead) samples. Roughness measurements show increasing RMS roughness as follows: 3-1<1-1<2-1. This follows the order of domain sizes seen by the AFM (FIG. 4) and is in a good agreement with pore sizes as determined by mercury intrusion porosimetry.

| Example | R_{RMS} | | Dmax (Hg), nm |
|---|---|---|---|
| 1-1 | 76.6 | nm | 89.1 |
| 2-1 | 1680 | nm | 2616 |
| 3-1 | 55.2 | nm | 26.3 |

1. A carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1.

2. The material of claim 1 having a pore size ranging from about 10 nm to about 5000 nm and a bulk density ranging from 0.06 g/ml to 0.15 g/ml.

3. The material of claim 1 having a pore size ranging from about 20 nm to about 300 nm and a bulk density ranging from about 0.3 g/ml to about 0.5 g/ml.

4. The material of claim 1 having a pore size ranging from about 50 nm to about 150 nm and a bulk density ranging from about 0.3 g/ml to about 0.5 g/ml.

5. A polycondensation resin comprising a high-ortho phenol resin having a pore size ranging from about 10 nm to about 500 nm and an intraparticular density ranging from about 2% to about 25%.

6. The resin of claim 5 having a pore size of from about 25 nm to about 300 nm and an intraparticular porosity ranging from about 5% to about 20%.

7. The resin of claim 5 having a pore size of from about 50 nm to about 150 nm and an intraparticular porosity ranging from about 8% to about 15%.

8. A chelating agent comprised of the material of claim 5.

9. A carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1×10⁻³.

10. The material of claim 9 having a pore size ranging from about 10 nm to about 5000 nm and a bulk density ranging from 0.06 g/ml to 0.15 g/ml.

11. The material of claim 9 having a pore size ranging from about 20 nm to about 300 nm and a bulk density ranging from about 0.3 g/ml to about 0.5 g/ml.

12. The material of claim 9 having a pore size ranging from about 50 nm to about 150 nm and a bulk density ranging from about 0.3 g/ml to about 0.5 g/ml.

13. An adsorbent comprising the carbonaceous material of claim 12.

14. An adsorbent comprising the carbonaceous material of claim 9.

15. A film comprising the carbonaceous material of claim 9.

16. A carbonaceous material having a pore size (p) ranging from a lower limit (a) to an upper limit (z) and a bulk density (σ) ranging from a lower limit (b) to an upper limit (y) where the comparative variability (g) defined as (y−b)/(z−a) is less than 1×10⁻⁵.

17. The material of claim 16 having a pore size ranging from about 10 nm to about 5000 nm and a bulk density ranging from 0.06 g/ml to 0.15 g/ml.

18. The material of claim 16 having a pore size ranging from about 20 nm to about 300 nm and a bulk density ranging from about 0.3 g/ml to about 0.5 g/ml.

19. The material of claim 16 having a pore size ranging from about 50 nm to about 150 nm and a bulk density ranging from about 0.3 g/ml to about 0.5 g/ml.

20. An adsorbent comprising the carbonaceous material of claim 16.
